(19) United States
(12) Patent Application Publication
(10) Pub. No.: US 2015/0029424 A1
(43) Pub. Date: Jan. 29, 2015

(54) VARIABLE FOCAL LENGTH LENS

(71) Applicant: INTERNATIONAL BUSINESS MACHINES CORPORATION, Armonk, NY (US)

(72) Inventors: Michael S. Gordon, Yorktown Heights, NY (US); John U. Knickerbocker, Monroe, NY (US); Minhua Lu, Mohegan Lake, NY (US); Robert J. Polastre, Cold Spring, NY (US)

(21) Appl. No.: 14/340,164

(22) Filed: Jul. 24, 2014

Related U.S. Application Data
(60) Provisional application No. 61/858,346, filed on Jul. 25, 2013.

(51) Int. Cl. G02C 7/08; G02F 1/29; G02F 1/00; G02C 7/04

(52) U.S. Cl. CPC G02C 7/083; G02C 7/049; G02C 7/041; G02F 1/29; G02F 1/0045; G02C 2202/16; G02C 2202/18; G02F 2001/294
USPC 349/13

(57) ABSTRACT

An adjustable focal length lens structure comprising a first adjustable focal length lens. The first adjustable focal length lens comprises an inner surface of a first side having a first curvature. The first adjustable focal length lens also comprises a first transparent conducting electrode on the first side. The first adjustable focal length lens also comprises an inner surface of a second side having a second curvature. The first adjustable focal length lens also comprises a second transparent conducting electrode on the second side. The first adjustable focal length lens also comprises one or more layers of a first liquid crystal material disposed between the inner surface of the first side and the inner surface of the second side, wherein the first liquid crystal material has two or more effective indices of refraction.

### BACKGROUND

The present invention relates generally to thin lenses, and more specifically to a cholesteric liquid crystal adjustable focal length lens.

In optics, a thin lens is a lens with a thickness (distance along the optical axis between the two surfaces of the lens) that is negligible compared to the radii of curvature of the lens surfaces. The focal length of a thin lens may be approximated by using the thin lens approximation equation. The focal length of a thin lens in air can be adjusted either by changing the curvature of the lens or by changing the index of refraction.

Liquid crystals are matter in a state that has properties between those of conventional liquid and those of solid crystal. For example, a liquid crystal may flow like a liquid, but its molecules may be oriented in a crystal-like way. There are many different types of liquid crystal phases, which can be distinguished by their different molecular arrangement and optical properties (such as birefringence). Birefringence is often quantified as the maximum difference between refractive indices exhibited by the material. Crystals with asymmetric crystal structures are often birefringent.

Liquid crystals also are molecules with optical and dielectric anisotropy. Optical anisotropy, i.e., birefringence, allows liquid crystals to modulate light. For example, when light polarization is parallel to the liquid crystal molecules, the index of refraction is nₑ, and when light polarization is perpendicular to the liquid crystal molecules, the index of refraction is nₒ. Both states can be transparent. Dielectric anisotropy allows liquid crystals to respond to external electric fields and orientate molecules either towards parallel or perpendicular to the electric field.

Liquid crystals have been used in a wide variety of electro-optic display applications. In these devices, a thin layer of liquid crystal (usually nematic) is sandwiched between parallel cell walls, which have been treated to control the alignment of the liquid crystal director. When a potential difference is applied to electrodes, at least one of which is transparent, on either side of the liquid crystal, the resulting electric field causes a reorientation of the molecules and a change in the optical behavior of the liquid crystal layer.

The cholesteric (or chiral nematic) liquid crystal phase is typically composed of nematic mesogenic molecules containing a chiral center which produces intermolecular forces that favor alignment between molecules at a slight angle to one another. This leads to the formation of a structure which can be visualized as a stack of very thin 2-D nematic-like layers with the liquid crystal director in each layer twisted with respect to those above and below. In this structure, the liquid crystal directors actually form in a continuous helical pattern about the layer. The cholesteric phase exhibits chirality. Only chiral molecules (i.e., those that have no internal planes of symmetry) can give rise to such a phase. This phase exhibits a twisting of the molecules perpendicular to the liquid crystal director, with the molecular axis parallel to the liquid crystal director.

### SUMMARY

Aspects of an embodiment of the present invention disclose an adjustable focal length lens structure. The adjustable focal length lens structure comprises a first adjustable focal length lens. The first adjustable focal length lens comprises an inner surface of a first side having a first curvature. The first adjustable focal length lens also comprises a first transparent conducting electrode on the first side. The first adjustable focal length lens also comprises an inner surface of a second side having a second curvature. The first adjustable focal length lens also comprises a second transparent conducting electrode on the second side. The first adjustable focal length lens also comprises one or more layers of a first liquid crystal material disposed between the inner surface of the first side and the inner surface of the second side, wherein the first liquid crystal material has two or more effective indices of refraction.

### BRIEF DESCRIPTION OF THE SEVERAL VIEWS OF THE DRAWINGS

The following detailed description, given by way of example and not intended to limit the disclosure solely thereto, will best be appreciated in conjunction with the accompanying drawings, in which:

FIG. 1 depicts a lens having an adjustable focal length lens integrated therein (not shown), in accordance with an embodiment of the present invention;

FIG. 2 depicts a cross-sectional view of the lens of FIG. 1 having the adjustable focal length lens integrated therein, in accordance with an embodiment of the present invention;

FIG. 3 depicts a layer view of the adjustable focal length lens of FIGS. 1 and 2, in accordance with an embodiment of the present invention;

FIG. 4A through 4C depict exemplary pixilation patterns of the transparent conducting electrode layers of FIG. 3, in accordance with multiple embodiments of the present invention;

FIG. 5 depicts a cross-sectional view of a portion of the adjustable focal length lens integrated within the lens of FIG. 1, in accordance with an embodiment of the present invention;

FIG. 6 depicts a cross-sectional view of a portion of the adjustable focal length lens integrated within the lens of FIG. 1, in accordance with another embodiment of the present invention;

FIG. 7 illustrates a flowchart of a process for forming an adjustable focal length lens, in accordance with an embodiment of the present invention;

FIG. 8 depicts a lens having the adjustable focal length lens of FIGS. 1 and 2 stacked with another adjustable focal length lens integrated therein, in accordance with an embodiment of the present invention.

### DETAILED DESCRIPTION

Embodiments of the present invention recognize that lenses that can change their focal length by changing the curvature of the lens are impractical. Such lenses are typically bulky (a few hundred microns thick), require a high switching voltage (about 40-50 Volts or more) between different curvatures, and have a limited range of focal length adjustability.

Embodiments of the present invention propose a cholesteric liquid crystal adjustable focal length lens. The focal length of the lens is adjusted by changing the effective index of refraction of the lens itself. The self-assembled helical molecular configuration of cholesteric liquid crystal automatically addresses the anisotropic issues that present in most twist nematic (TN), in plane switching (IPS), and vertical alignment (VA) applications. The birefringence of the cholesteric liquid crystal adjustable focal length lens of about 0.1 or greater, preferably 0.2 or greater, enables a large range of adjustability of focal length. The cholesteric liquid crystal adjustable focal length lens is thin, having a liquid crystal layer about 5-10 microns thick, with a switching voltage that is less than 20 volts, preferably less than 10 volts. The cholesteric liquid crystal adjustable focal length lens may be thicker in portions due to the curvature differences in the surfaces of the lens requiring a switching voltage of about 50 volts or higher at the thicker portions of the lens. The cholesteric liquid crystal adjustable focal length lens can be made to have bistable or multi-stable states for switching the lens to certain focal lengths, using a temporary voltage, without the need of power to maintain the lens in a particular state. The cholesteric liquid crystal adjustable focal length lens has a high optical throughput of about 95% or higher that can be achieved without a polarizer.

The cholesteric liquid crystal adjustable focal length lens may have many potential applications and structures. For example, the cholesteric liquid crystal adjustable focal length lens may be a standalone lens or part of a larger lens. If the cholesteric liquid crystal adjustable focal length lens is part of a larger lens it may be embedded in or attached to one of the surfaces of the larger lens. The cholesteric liquid crystal adjustable focal length lens may be used in many applications, such as the following: camera applications (e.g., smart phones, security cameras); visual aid applications (e.g., adjustable contact lens, adjustable glasses, or bifocal or progressive contact lenses or glasses); or other visual aid applications (e.g., ultraviolet light (UV) blocking, night vision, changeable color contact lenses, etc.). Cholesteric liquid crystal adjustable focal length lenses may also be stacked to provide a combination of benefits (e.g., adjustable contact lenses with UV protection, greater range of adjustment for contact lenses, different pitches of each cholesteric liquid crystal adjustable focal length lens to make band gap filters, etc.).

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed present invention, as oriented in the drawing figures. The terms “overlying”, “underlying”, “atop”, “on top”, “positioned on” or “positioned atop” mean that a first element, such as a first structure, is present on a second element, such as a second structure, wherein intervening elements, such as an interface structure may be present between the first element and the second element. The term “direct contact” means that a first element, such as a first structure, and a second element, such as a second structure, are connected without any intermediary conducting, insulating or semiconductor layers at the interface of the two elements.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

Weight percent, percent by weight, % by weight, and the like are synonyms that refer to the concentration of a substance as the weight of that substance divided by the weight of the composition and multiplied by 100.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention will now be described in detail with reference to the figures.

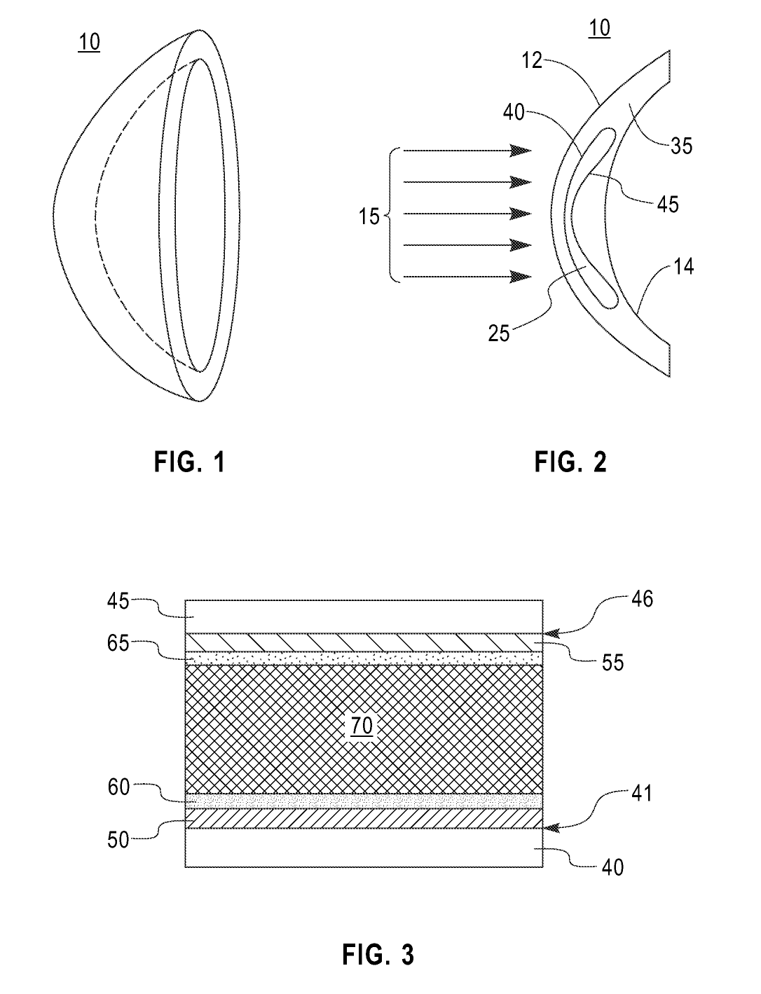

FIGS. 1 and 2 depict various perspectives of a lens 10 having an adjustable focal length lens 25 integrated therein, in accordance with an embodiment of the present invention. FIG. 1 depicts a three dimensional image of lens 10 having adjustable focal length lens 25 (not shown) integrated within. In one embodiment, as shown, lens 10 is a contact lens. In other embodiments, lens 10 may be a lens for glasses, a camera lens, or any other type of lens. In general, lens 10 may be a spherical shape, a parabolic shape, or a cylindrical shape. In yet another embodiment, adjustable focal length lens 25 (not shown) may be a standalone lens not integrated within another structure or lens.

FIG. 2 depicts an exemplary cross-sectional view of lens 10 of FIG. 1 having adjustable focal length lens 25 integrated therein, in accordance with an embodiment of the present invention. Lens 10 is composed of lens material 35 and includes two surfaces, an outer surface 12 (being the surface closest to light source 15) and an inner surface 14 (being the surface farthest from light source 15), both of which are spherical. In other embodiments, the two surfaces may be parabolic or cylindrical. In yet another embodiment, if lens 10 is not specifically a lens, outer surface 12 and inner surface 14 may be any curved surface. The curved surface may be curved, “locally” curved, “piecewise curved.” Inner surface 14 is concave. Outer surface 12 is convex and opposite inner surface 14. Lens 10 has a thickness that spans in a horizontal direction between inner surface 14 and outer surface 12. Adjustable focal length lens 25 is located within the thickness of lens 10. In one embodiment, if lens 10 is a contact lens, adjustable focal length lens 25 is positioned within lens 10 such that adjustable focal length lens 25 is in the optical region of the contact lens (e.g., the center region of the contact, a range of about 4 mm to about 10 mm in diameter, preferably about 6 mm in diameter) leaving the outer region of the contact lens for driving electronics (e.g., power sources).

For example, driving electronics may be one or more of the following: one or more sensors or smart sensors from bio-metric input; one or more sensors; one or more smart sensors; one or more wireless antenna devices; one or more integrated power supplies such as an integrated battery, capacitor or other power source; one or more integrated energy scavenging devices; one or more external power sources; one or more smart control circuits to adjust the lens with input from a sensor or sensors; one or more wired or wireless communication devices; one or more storage devices which can input voltage settings to one or more pre-set or preferred lens control settings and/or monitor and track use condition settings over time or from previous settings on demand with an option to reset the lens settings to a predetermined state in case of loss of power or alternate in use parameter. For example, a power source may be a thin film battery, a radio frequency (RF) power amplifier, or any other suitable power source. Examples of suitable driving electronics and a power source are described in U.S. patent application Ser. No. ______ filed concurrently with this application entitled “Thin, flexible microsystem with integrated energy source,” the entirety of which is incorporated by reference herein.

The particular dimensions (including dimensions attributable to thickness, diameter, curvature, and etc.) of lens 10 may vary. Lenses are classified by the curvature of the two optical surfaces. Therefore, in other embodiments, lens 10 may one of the following: biconvex (or double convex, or just convex) if both surfaces are convex; equiconvex, if both surfaces have the same radius of curvature; biconcave (or just concave) if the lens has two concave surfaces; if one of the surfaces is flat, the lens is piano-convex or piano-concave depending on the curvature of the other surface; convex-concave or meniscus, if the lens has one convex side and one concave side; or any other type of lens.

Lens material 35 can include any suitable material that provides support for adjustable focal length lens 25, contain adjustable focal length lens 25, and/or otherwise form a structural and/or functional body of lens 10. Lens material 35 is substantially transparent, with a transmittance of 40% to 99%, preferably 70% to 99%, and biocompatible. In one embodiment, lens material 35 comprises a soft polymer material including but not limited to, a hydrogel, a silicone based hydrogel, a polyacrlyamide, or a hydrophilic polymer. In other embodiments, lens material 35 may comprise polyethylene terephthalate (“PET”), polymethyl methacrylate (“PMMA”), polyhydroxyethylmethacrylate (polyHEMA) based hydrogels, or combinations thereof. I yet another embodiment, lens material 35 may comprise a rigid gas permeable material. In yet another embodiment, lens material may comprise glass, plastic (such as a polycarbonate), or any other suitable material. In one embodiment, lens material 35, outer surface 12, and inner surface 14 comprise the same material. In other embodiments, lens material 35 may comprise a different material than outer surface 12 and inner surface 14.

Adjustable focal length lens 25 is composed of a plurality of layers, including a substrate layer 40 and a substrate layer 45. Adjustable focal length lens 25 also comprises substrate surface 41 and substrate surface 46 which are the inner surfaces of substrate layer 40 and substrate layer 45, respectively (as shown in FIG. 3). Substrate surface 41 and substrate surface 46 both may be spherical, parabolic, cylindrical, or any curved surface. Substrate surface 46 is concave. Substrate surface 41 is convex and opposite substrate surface 46. In general, as illustrated in FIG. 2, the width of adjustable focal length lens 25 is thinnest (relative to the width of adjustable focal length lens 25 at other areas) at the center point of adjustable focal length lens 25, with a thicker edge near the perimeter of adjustable focal length lens 25 (as shown in FIG. 5). The plurality of layers of adjustable focal length lens 25 are discussed in detail with reference to FIG. 3.

The particular dimensions (including dimensions attributable to thickness, diameter, curvature, and etc.) of adjustable focal length lens 25 may vary. The particular dimensions of adjustable focal length lens 25 can be tailored such that adjustable focal length lens 25 has a particular focal length (or power). The focal length of a lens can be determined using the lens maker's equation, as shown in Equation (1), or the thin lens approximation equation, as shown in Equation (2).

$$\begin{matrix}P = \frac{1}{f} = ( n - 1 ) [ \frac{1}{{R}_{1}} - \frac{1}{{R}_{2}} + \frac{( n - 1 ) d}{{nR}_{1} {R}_{2}} ] & Equation ( 1 ) \\ \frac{1}{f} \approx ( n - 1 ) [ \frac{1}{{R}_{1}} - \frac{1}{{R}_{2}} ] & Equation ( 2 )\end{matrix}$$

In Equation (1) and (2): P is the power of the lens; f is the focal length of the lens; n is the index of refraction of the lens material; R₁ is the radius of curvature of the lens surface closest to the light source; R₂ is the radius of curvature of the lens surface farthest from the light source; and d is the thickness of the lens (the distance along the optical axis between the two surfaces). The signs of the lens' radii of curvature indicate whether the corresponding surfaces are convex or concave. The sign convention used to represent this varies, but an example is: if R₁ is positive the surface closest to the light source is convex and if R₁ is negative the surface is concave; the signs are reversed for the surface of the lens farthest from the light source; if R₂ is positive the surface is concave and if R₂ is negative the surface is convex. If either radius is infinite, the corresponding surface is flat.

In one embodiment, the dimensions of adjustable focal length lens 25 can be tailored such that adjustable focal length lens 25 will fit within lens 10. For example, if outer surface 12 of lens 10 is convex with a curvature of C₁ and inner surface 14 of lens 10 is concave with a curvature of C₂, substrate surface 41 of adjustable focal length lens 25 can be also be convex with a curvature of C₁ (or a curvature substantially similar to C₁) and substrate surface 46 of adjustable focal length lens 25 can be concave with a curvature of C₂ (or a curvature substantially similar to C₂). In another embodiment, adjustable focal length lens 25 can be tailored such that adjustable focal length lens 25 will fit within lens 10 but the dimensions of adjustable focal length lens 25 may be different. In other embodiments, adjustable focal length lens 25 can be a standalone lens and have any desirable dimensions. In other embodiments, adjustable focal length lens 25 can be part of another lens, either embedded in or attached to one of the surfaces of the other lens.

FIG. 3 depicts a layer view of the plurality of layers of adjustable focal length lens 10 of FIG. 2, in accordance with an embodiment of the present invention.

FIG. 3 depicts layers of adjustable focal length lens 25 with substrate layer 40 shown on the bottom and substrate layer 45 shown on top. In one embodiment, the plurality of layers of adjustable focal length lens 25 comprise substrate layers 40 and 45, substrate surfaces 41 and 46, transparent conducting electrode layers 50 and 55, alignment layers 60 and 65, and cholesteric liquid crystal composition layer 70.

In one embodiment, substrate layers 40 and 45 provide a base for formation of adjustable focal length lens 25. Substrate layers 40 and 45 may also be a structural support member during manufacture, use, or both, of adjustable focal length lens 25. Substrate layers 40 and 45 may be transparent over the wavelength range of operation of adjustable focal length lens 25. Substrate layers 40 and 45 are substantially transparent and biocompatible. In one embodiment, substrate layers 40 and 45 each have a thickness in the range of about 5 microns to 600 microns.

In one embodiment, substrate layers 40 and 45 comprise soft polymer material including but not limited to, a hydrogel, a silicone based hydrogel, a polyacrlyamide, or a hydrophilic polymer. In other embodiments, substrate layers 40 and 45 may comprise polyethylene terephthalate (“PET”), polymethyl methacrylate (“PMMA”), polyhydroxyethylmethacrylate (polyHEMA) based hydrogels, or combinations thereof. I yet another embodiment, substrate layers 40 and 45 may comprise a rigid gas permeable material. In yet another embodiment, substrate layers 40 and 45 may comprise glass, plastic (such as a polycarbonate), or any other suitable material. In one embodiment, substrate layers 40 and 45, substrate surface 41, and substrate surface 46 comprise the same material because substrate surface 41 and substrate surface 46 are the inner surfaces of substrate layer 40 and substrate layer 45, respectively. In other embodiments, substrate layers 40 and 45 may comprise a different material than substrate surface 41 and substrate surface 46. Substrate layers 40 and 45 have a curved shape. The curvature of substrate surfaces 41 and 46, which are adjacent to transparent conducting electrode layers 50 and 55, respectively, determine the switchable optical power of adjustable focal length lens 25.

In one embodiment, transparent conducting electrode layers 50 and 55 may comprise indium tin oxide (ITO), however those skilled in the art understand that other transparent conducting oxides can be used, such as indium zinc oxide (IZO), Al-doped zinc oxide (AZO), Ga-doped zinc oxide (GZO), or indium gallium zinc oxide (IGZO). In other embodiments, any combination of ITO, IZO, AZO, GZO, and IGZO can be used. In another embodiment, transparent conducting electrode layers 50 and 55 may comprise a conducting polymer or any other transparent conductive material. In one embodiment, transparent conducting electrode layers 50 and 55 each have a thickness in the range of about 100 angstroms to 1,000 angstroms. Transparent conducting electrode layers 50 and 55 being on the inner surfaces of substrate layers 40 and 45, respectively, allows for a shorter distance between the two electrode layers and therefore a smaller switching voltage is needed (e.g., less than 20 volts, preferably less than 10 volts). In other embodiments, transparent conducting electrode layers 50 and 55 can be on the outer surfaces of substrate layers 40 and 45, respectively.

In one embodiment, alignment layers 60 and 65 comprise any suitable material that can facilitate proper alignment of the liquid crystals in cholesteric liquid crystal composition layer 70. Alignment layer 60 and 65 have a surface capable of orienting the liquid crystals in cholesteric liquid crystal composition layer 70 in a designed direction. In one embodiment, alignment layers 60 and 65 each have a thickness in the range of about 50 angstroms to 20,000 angstroms.

In one embodiment, alignment layers 60 and 65 may comprise a transparent polymer layer suitable for mechanical alignment methods. For example, alignment layers 60 and 65 may comprise polyvinyl alcohol, polyamide, polyimide films, polyolefins (e.g., polyethylene or polypropylene), polyesters (e.g., polyethylene terphthalate or polyethylene naphthalate), and polystyrene. The polymer film can be a homopolymer, a copolymer, or a mixture of polymers. In another embodiment, alignment layers 60 and 65 may comprise a photo-orientable polymer. Suitable photo-orientable polymers include polyimides including, for example, substituted 1,4-benzenediamines. In yet another embodiment, alignment layers 60 and 65 may comprise a polymer suitable for ion beam alignment. In other embodiments, alignment layers 60 and 65 may comprise a transparent inorganic material, such as amorphous carbon, amorphous silicon, SiO₂, or SiNₓ.

In general, cholesteric liquid crystal composition layer 70 comprises one or more layers of a cholesteric liquid crystal composition. The term “cholesteric liquid crystal composition” refers to a composition including, but not limited to, a cholesteric liquid crystal compound, a cholesteric liquid crystal polymer or a cholesteric liquid crystal precursor such as, for example, lower molecular weight cholesteric liquid crystal compounds including monomers and oligomers that can be reacted to form a cholesteric liquid crystal polymer.

Cholesteric liquid crystal compounds include molecular units that are chiral in nature (e.g., molecules that do not possess a mirror plane) and molecular units that are mesogenic in nature (e.g., molecules that exhibit liquid crystal phases) and can be polymers. The cholesteric liquid crystal compounds may comprise achiral liquid crystal compounds (nematic) mixed with or containing a chiral unit. Cholesteric liquid crystal compounds include compounds having a cholesteric liquid crystal phase in which the liquid crystal director of the liquid crystal rotates in a helical fashion along the dimension perpendicular to the director.

The pitch of a cholesteric liquid crystal composition is the distance (in a direction perpendicular to the liquid crystal director and along the axis of the cholesteric helix) that it takes for the liquid crystal director to rotate through 360°. The pitch of a cholesteric liquid crystal composition can be induced by mixing or otherwise combining (e.g., by copolymerization) a chiral compound with a nematic liquid crystal compound. The cholesteric phase can also be induced by a chiral non-liquid crystal material. The pitch may depend on the relative ratios by weight of the chiral compound and the nematic liquid crystal compound or material. The helical twist of the liquid crystal director results in a spatially periodic variation in the dielectric tensor of the material, which in turn gives rise to the wavelength selective reflection of light. For light propagating along the helical axis, Bragg reflection generally occurs when the wavelength, λ, is in the following range, nₒp<λ<nₑp, where p is the pitch and nₒ and nₑ are the principal refractive indices of the cholesteric liquid crystal composition. For example, the pitch can be selected such that the Bragg reflection is peaked in the visible, ultraviolet, or infrared wavelength regimes of light.

Cholesteric liquid crystal compounds, including cholesteric liquid crystal polymers, are generally known and typically any of these materials can be used in a cholesteric liquid crystal composition. Suitable cholesteric liquid crystal compounds may be selected for a particular application based on one or more factors including, for example, refractive indices, surface energy, pitch, process-ability, clarity, color, low absorption in the wavelength of interest, compatibility with other components (e.g., a nematic liquid crystal compound), molecular weight, ease of manufacture, availability of the liquid crystal compound or monomers to form a liquid crystal polymer, rheology, method and requirements of curing, ease of solvent removal, physical and chemical properties (for example, flexibility, tensile strength, solvent resistance, scratch resistance, and phase transition temperature), and ease of purification.

Cholesteric liquid crystal polymers are generally formed using chiral (or a mixture of chiral and achiral) molecules (including monomers) that can include a mesogenic group (e.g., a rigid group that typically has a rod-like structure to facilitate formation of a liquid crystal phase). Mesogenic groups include, for example, para-substituted cyclic groups (e.g., para-substituted benzene rings). The mesogenic groups are optionally bonded to a polymer backbone through a spacer. The spacer can contain functional groups having, for example, benzene, pyridine, pyrimidine, alkyne, ester, alkylene, alkene, ether, thioether, thioester, and amide functionalities. The length or type of spacer can be altered to provide different properties such as, for example, solubilities in solvent(s).

Examples of cholesteric liquid crystal polymers include polymers having a chiral or achiral polyester, polycarbonate, polyamide, polyacrylate, polymethacrylate, polysiloxane, or polyesterimide backbone that include mesogenic groups optionally separated by rigid or flexible co-monomers. Other suitable cholesteric liquid crystal polymers have a polymer backbone (for example, a polyacrylate, polymethacrylate, polysiloxane, polyolefin, or polymalonate backbone) with chiral and achiral mesogenic side-chain groups. The side-chain groups are optionally separated from the backbone by a spacer, such as, for example, an alkylene or alkylene oxide spacer, to provide flexibility.

Cholesteric liquid crystal compounds generally exhibit three states. In the first, the cholesteric helical axis is oriented normal to the tangent plane of the substrate layers of the adjustable focal length lens. This is known as the planar state. The planar state will reflect light by the Bragg effect as explained above. Thus, the planar state may appear colored and reflective or, if the pitch is in the infrared, transparent. The second state is achieved by the application of an electric field sufficient to disrupt the planar state into a disordered, focal conic state. Depending on the nature of the cholesteric composition and the pitch of the cholesteric composition, the focal conic state may be weakly or strongly light scattering. At higher voltages, the pitch is completely unwound and the cholesteric molecules become oriented perpendicular to the tangent plane of the substrate layers of the adjustable focal length lens. This is known as the homeotropic state, which is transparent. In pure cholesteric materials, the planar state is stable, the homeotropic state is unstable and the focal conic state is metastable, taking from seconds to hours to revert to the planar state upon removal of an electric field. By stabilizing the appropriate cholesteric state with a polymer network, the focal conic-planar transition time may be greatly reduced. Alternatively, the focal conic state can be stabilized such that it reverts to the planar state only if first switched to the homeotropic state, allowing bistable liquid crystal to be made.

The following are specific example embodiments of cholesteric liquid crystal composition layer 70. It is understood that the following examples are not exclusive and that there may be any number of other examples suitable for use in adjustable focal length lens 25.

In one embodiment, cholesteric liquid crystal composition layer 70 comprises a cholesteric liquid crystal composition with a pitch in the infrared wavelength range, about 1-2 microns to 5-10 microns, such that adjustable focal length lens 25 is transparent to visible light. In this embodiment, cholesteric liquid crystal composition layer 70 comprises at least a ½ pitch cholesteric liquid crystal composition layer to several full pitch cholesteric liquid crystal composition layers in order to have uniform angular distribution of the index of refraction. In this embodiment, the cholesteric liquid crystal compounds of the cholesteric liquid crystal composition are aligned parallel to the tangent plane of substrate surface 41 and substrate surface 46. This alignment allows the planar state with an index of refraction n=nₑ˜1.7 to be the default state when no voltage is applied. The homeotropic state with an index of refraction of n=nₒ˜1.5 is the “on state” when a voltage is applied. The focal conic state is an intermediate state. In this embodiment, the voltage needed to switch from the planar state to the homeotropic state is about 10-20 volts depending on thickness. In this embodiment, the thickness of cholesteric liquid crystal composition layer 70 is about 5-10 microns.

In another embodiment, cholesteric liquid crystal composition layer 70 comprises a cholesteric liquid crystal composition with a pitch in the UV wavelength range, about 100 nm to about 310 nm, such that adjustable focal length lens 25 is transparent to visible light but UV light is reflected. In this embodiment, cholesteric liquid crystal composition layer 70 comprises at least a ½ pitch cholesteric liquid crystal composition layer to several full pitch cholesteric liquid crystal composition layers in order to have uniform angular distribution of the index of refraction. In this embodiment, the cholesteric liquid crystal compounds of the cholesteric liquid crystal composition are aligned parallel to the tangent plane of substrate surface 41 and substrate surface 46. This alignment allows the planar state with an index of refraction n=nₑ˜1.7 to be the default state when no voltage is applied. The homeotropic state with an index of refraction of n=nₒ˜1.5 is the “on state” when a voltage is applied. The focal conic state is an intermediate state. In this embodiment, the voltage needed to switch from the planar state to the homeotropic state is about 10-50 volts depending on thickness. In this embodiment, the thickness of cholesteric liquid crystal composition layer 70 is about 5-10 microns.

In yet another embodiment, cholesteric liquid crystal composition layer 70 comprises a bistable cholesteric liquid crystal composition with a pitch in the infrared wavelength range, about 1-2 microns to 5-10 microns, such that adjustable focal length lens 25 is transparent to visible light. In this embodiment, cholesteric liquid crystal composition layer 70 comprises at least a ½ pitch cholesteric liquid crystal composition layer to several full pitch cholesteric liquid crystal composition layers in order to have uniform angular distribution of the index of refraction. In this embodiment, the cholesteric liquid crystal compounds of the cholesteric liquid crystal composition are aligned parallel to the tangent plane of substrate surface 41 and substrate surface 46. This alignment allows the planar state with an index of refraction n=nₑ˜1.7 to be the default state when no voltage is applied. The homeotropic state with an index of refraction of n=nₒ˜1.5 is polymer stabilized such that when the appropriate switching voltage is applied the bistable cholesteric liquid crystal composition will switch to the homeotropic state and stay in that state even when the voltage is removed. The focal conic state is an intermediate state. In this embodiment, the voltage needed to switch from the planar state to the homeotropic state is about 10-20 volts depending on thickness. In this embodiment, the thickness of cholesteric liquid crystal composition layer 70 is about 5-10 microns.

Polymer stabilization can be done in several ways. Polymer networks can be formed during the initial stages of cholesteric liquid crystal composition preparation by combining a small quantity of reactive monomer, a photoinitiator with cholesteric liquid crystal molecules, and a small amount of chiral dopant to produce the desired pitch. After the desired alignment (or texture) is established through the combination of surface preparations and applied field, ultraviolet light may be used to photopolymerize the cholesteric liquid crystal composition. Photoinitiators can be activated by electromagnetic radiation or particle irradiation. Examples of suitable photoinitiators include, onium salt photoinitiators, organometallic photoinitiators, metal salt cationic photoinitiators, photodecomposable organosilanes, latent sulphonic acids, phosphine oxides, cyclohexyl phenyl ketones, amine substituted acetophenones, and benzophenones. Generally, ultraviolet (UV) irradiation is used to activate the photoinitiator, although other light sources can be used. Photoinitiators can be chosen based on the absorption of particular wavelengths of light.

In yet another embodiment, cholesteric liquid crystal composition layer 70 comprises a bistable cholesteric liquid crystal composition with a pitch in the infrared wavelength range, about 1-2 microns to 5-10 microns, such that adjustable focal length lens 25 is transparent to visible light. In this embodiment, cholesteric liquid crystal composition layer 70 comprises at least a ½ pitch cholesteric liquid crystal composition layer to several full pitch cholesteric liquid crystal composition layers in order to have uniform angular distribution of the index of refraction. In this embodiment, the cholesteric liquid crystal compounds of the cholesteric liquid crystal composition are aligned perpendicular to the tangent plane of substrate surface 41 and substrate surface 46. This alignment allows the homeotropic state with an index of refraction of n=nₒ˜1.5 to be the default state when no voltage is applied. In this embodiment, the dielectric anisotropy of the liquid crystal material is negative. This type of liquid crystal material will rotate to the direction perpendicular to the electric field direction when voltage is applied. The planar state with an index of refraction n=nₑ˜1.7 is the “on state” when a voltage is applied. The focal conic state is an intermediate state. In this embodiment, the voltage needed to switch from the homeotropic state to the planar state is about 10-20 volts depending on thickness. In this embodiment, the thickness of cholesteric liquid crystal composition layer 70 is about 5-10 microns.

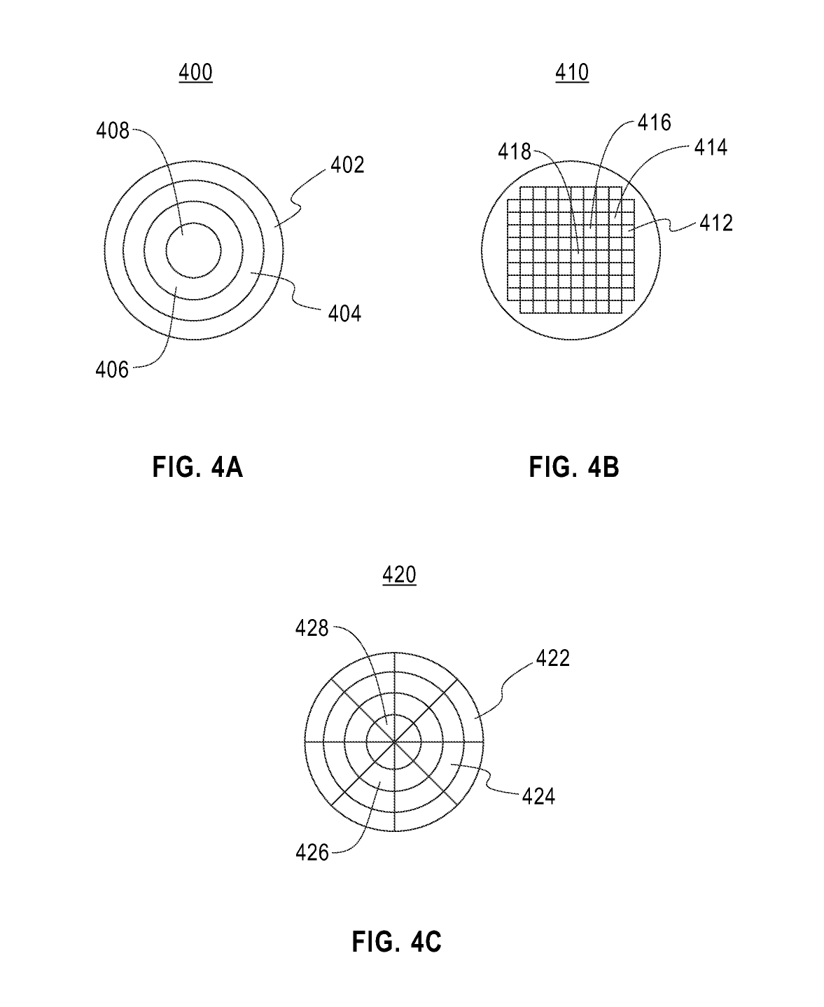

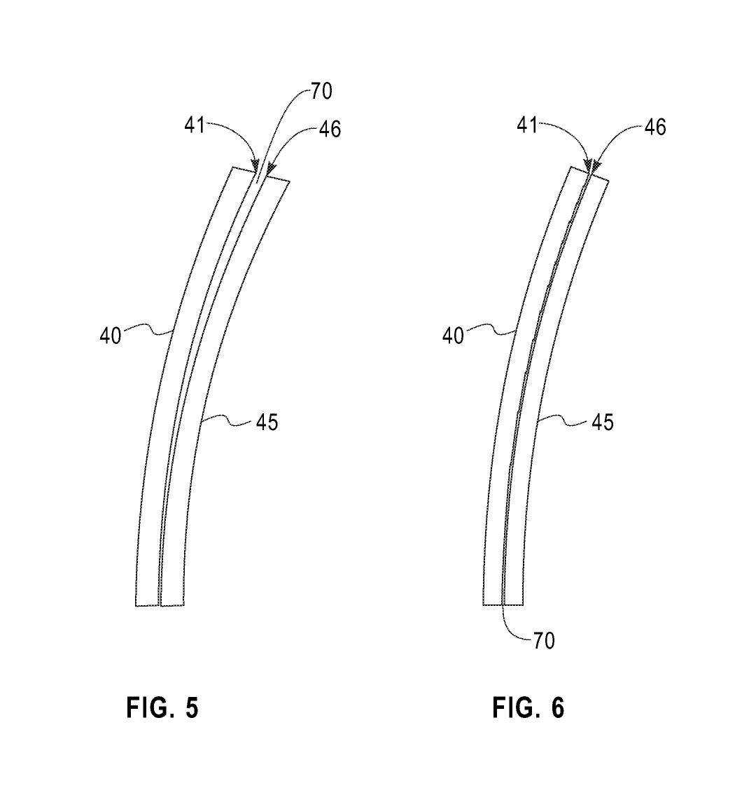

FIGS. 4A through 4C depict exemplary pixilation patterns of transparent conducting electrode layers 50 and 55 of FIG. 3, in accordance with multiple embodiments of the present invention.

In one embodiment, substrate surface 41 and substrate surface 46 of adjustable focal length lens 25 have different curvatures (as shown in FIG. 5). Because of this curvature difference the thickness of cholesteric liquid crystal composition layer 70 is variable at different locations throughout adjustable focal length lens 25 (i.e., the distance between transparent conducting electrode layers 50 and 55 is different) (as shown in FIG. 5). This variability means that a higher voltage is needed in the thicker areas where the distance between transparent conducting electrode layers 50 and 55 is the greatest. To accommodate for the variability a few approaches are envisioned. In one embodiment, adjustable focal length lens 25 itself can be made with a saw tooth structure (as shown in FIG. 6) to reduce the thickness difference while preserving the curvature as described in reference to FIG. 6. In another embodiment, a conducting leaf can be inserted in the thicker portions of adjustable focal length lens 25 to boost the voltage. In yet another embodiment, different pixilation patterns of transparent conducting electrode layers 50 and 55 can be used such that a higher voltage can be applied to only the thicker portions of adjustable focal length lens 25.

FIG. 4A depicts a top down view of a possible pattern of transparent conducting electrode layers 50 and 55, pattern 400. Pattern 400 depicts annulus electrodes 402, 404, 406, and circle electrode 408 which together represent a transparent conducting electrode layer, such as transparent conducting electrode layers 50 or 55. Annulus electrodes 402, 404, and 406 are concentric with each other and with circle electrode 408. Annulus electrode 402 is shown at the periphery of the transparent conducting electrode layer. Annulus electrodes 404 and annulus electrode 406 are progressively smaller than annulus electrode 402 and are shown within annulus electrode 402. Circle electrode 408 is closest to the center of the transparent conducting electrode layer and is shown within annulus electrode 406. Annulus electrodes 402, 404, 406, and circle electrode 408 are each electrically isolated in order to have a distinct voltage applied to each electrode. In one embodiment, there may be a dielectric material that is electrically isolating the electrodes from each other. In another embodiment, there is a sufficient space between each respective electrode such as to create the necessary isolation.

FIG. 4B depicts a top down view of a possible pattern of transparent conducting electrode layers 50 and 55, pattern 410. Pattern 410 depicts rectangular pixels 412, 414, 416, and 418 which, along with other rectangular pixels, represent a transparent conducting electrode layer, such as transparent conducting electrode layers 50 or 55. The rectangular pixels form a grid pattern with each rectangle representing a distinct pixel. Rectangular pixel 412 is shown at the periphery of the transparent conducting electrode layer with rectangular pixel 418 shown closest to the center of the transparent conducting electrode layer. Rectangular pixels 412, 414, 416, and 418 are each electrically isolated in order to have a distinct voltage applied to each electrode. In one embodiment, there may be a dielectric material that is electrically isolating the electrodes from each other. In another embodiment, there is a sufficient space between each respective electrode as to create the necessary isolation. In one embodiment, distinct voltages can be applied to the individual pixels (e.g., rectangular pixels 412, 414, 416, and 418), such that the of refraction of cholesteric liquid crystal composition layer 70 will vary spatially for particular applications, such as bifocals, progressive lenses, sun or UV filtering, color filtering, or other vision corrections, such as an astigmatism correction effect, a double vision correction effect, a myopia correction effect, or a hyperopia correction effect.

FIG. 4C depicts a top down view of a possible pattern of transparent conducting electrode layers 50 and 55, pattern 420. Pattern 420 depicts arc shaped electrodes 422, 424, 426, and 428 which together, along with other arc shaped electrodes, represent a transparent conducting electrode layer, such as transparent conducting electrode layers 50 or 55. Arc shaped electrodes 422, 424, 426, and 428 which together, along with other arc shaped electrodes, are arranged in a concentric pattern. Arc shaped electrode 422 is shown at the periphery of the transparent conducting electrode layer. Arc shaped electrode 428 is shown closest to the center of the transparent conducting electrode layer. Arc shaped electrodes 422, 424, 426, and 428, along with other arc shaped electrodes are each electrically isolated in order to have a distinct voltage applied to each are shaped electrode. In one embodiment, there may be a dielectric material that is electrically isolating the are shaped electrodes from each other. In another embodiment, there is a sufficient space between each respective arc shaped electrode such as to create the necessary isolation.

FIG. 5 depicts a cross-sectional view of a portion of the adjustable focal length lens integrated within the lens of FIG. 1, in accordance with an embodiment of the present invention. FIG. 5 illustrates an exemplary adjustable focal length lens, with substrate surface 41 and substrate surface 46 having fixed curvatures. Substrate surface 41 and substrate surface 46 are the inner surfaces of substrate layer 40 and substrate layer 45, respectively. In this example, the width of cholesteric liquid crystal composition layer 70 between substrate surface 41 and substrate surface 46 is about 10 microns at the center of the adjustable focal length lens. The width of cholesteric liquid crystal composition layer 70 between substrate surface 41 and substrate surface 46 is greater (about 65 microns) as cholesteric liquid crystal composition layer 70 tapers outwardly to the perimeter of the adjustable focal length lens.

FIG. 6 depicts a cross-sectional view of a portion of the adjustable focal length lens integrated within the lens of FIG. 1, in accordance with another embodiment of the present invention. FIG. 6 illustrates another exemplary adjustable focal length lens in the form of a Fresnel type lens. Substrate surface 41 and substrate surface 46 are the inner surfaces of substrate layer 40 and substrate layer 45, respectively. In this example, the curvature of the adjustable focal length lens is conserved while the variation in gap between substrate surface 41 and substrate surface 46 is reduced by shifting the curved surface of a substrate (e.g., substrate surface 41 of substrate layer 40) creating a saw tooth structure with multiple steps towards the periphery of the adjustable focal length lens. Each step is representative of a spherical ring around the adjustable focal length lens. In this example, the voltage variation is reduced. In this example, the width of cholesteric liquid crystal composition layer 70 between substrate surface 41 and substrate surface 46 is about 10 microns at the center of the adjustable focal length lens and at the thinnest part of each step. The width of cholesteric liquid crystal composition layer 70 between substrate surface 41 and substrate surface 46 is about 15 microns at the thickest part of each step.

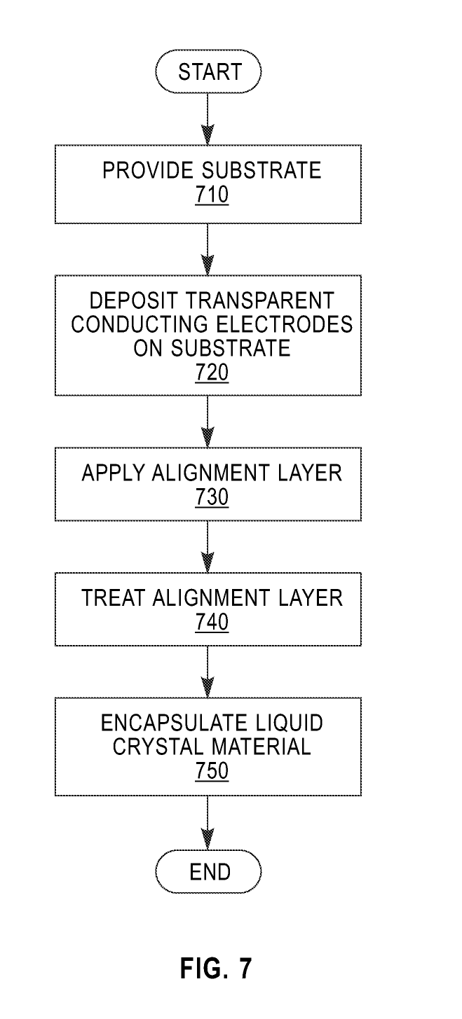

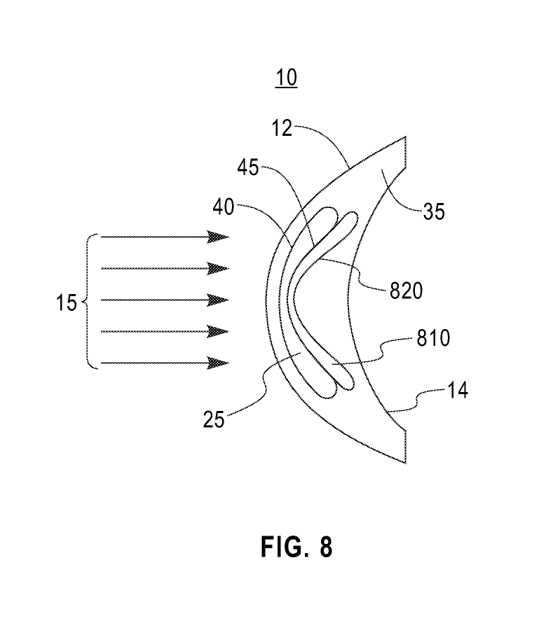

FIG. 7 illustrates a flowchart of a process for forming an adjustable focal length lens, in accordance with an embodiment of the present invention.

The process begins by providing a substrate (step 710). The substrate may comprise any material described above as suitable for substrate layers 40 and 45 in the discussion of FIG. 3. Substrate layers 40 and 45 are formed to specific dimensions based on the desired properties of adjustable focal length lens 25. The specific dimensions of substrate layers 40 and 45 may be tailored such that adjustable focal length lens 25 has a particular focal length.

In one embodiment, substrate layers 40 and 45 comprise a soft polymer material (e.g., hydrogel) and are prepared using one of the following methods: Spin-casting; Diamond turning; or Molding. Spin-casting involves whirling a liquid polymer in a revolving mold at high speed. Diamond turning involves cutting and polishing the substrate layer on a lathe. The surfaces of the layer is then polished with some fine abrasive paste, oil, and a small polyester cotton ball turned at high speeds. This process can be used to shape rigid substrate layer, but can also be used to shape soft polymer substrate layers. In the case of polymer substrate layers, the polymer substrate layers are cut from a dehydrated polymer that is rigid until water is reintroduced. Molding involves molten material being added and shaped by centrifugal forces to rotating molds.

In other embodiments, creating a saw tooth structure, as described in reference to FIG. 6, can be done by spin-casting or molding. The mold used during the spin-casting or molding process can be shaped to give substrate layer 40 or 45 an inner surface with the saw tooth structure.

After the substrate (substrate layers 40 and 45) is provided in desired dimensions, transparent conducting electrodes are deposited on the substrate (step 720). For example, transparent conducting electrode layers 50 and 55 are deposited on substrate surfaces 41 and 46, respectively. The transparent conducting electrodes may comprise any material described above as suitable for transparent conducting electrode layers 50 and 55 in the discussion of FIG. 3.

In one embodiment, transparent conducting electrode layers 50 and 55 are deposited using sputter deposition. In other embodiments, transparent conducting electrode layers 50 and 55 are deposited using chemical vapor deposition (CVD) or plasma-enhanced chemical vapor deposition (PECVD). In other embodiments, transparent conducting electrode layers 50 and 55 are deposited using printing, spin coating, dip coating, or spray coating methods. After the deposition of transparent conducting electrode layers 50 and 55 a particular pixilation pattern of transparent conducting electrode layers 50 and 55 is made, if desired. The pixilation pattern will also include electrode leads that extend past the end of transparent conducting electrode layers 50 and 55 such that the leads extend to the exterior of adjustable focal length lens 25 when completed. These leads are used to connect the transparent conducting electrode layers 50 and 55 to driving electronics. The connection between the leads and the driving electronics/power can be made by solder, conductive paste, or other suitable material.

For example, the pixilation pattern may be made by masking off the desired pattern on transparent conducting electrode layers 50 and 55 using either a silk-screening or photolithographic process. The areas of transparent conducting electrode layers 50 and 55 that are not needed are etched away chemically. In another example, a layer of photoresist is deposited over transparent conducting electrode layers 50 and 55. A mask with the desired pattern is placed over photoresist and the photoresist is exposed to ultraviolet light. The UV light causes the photoresist it shines on to lose its resistance to etching, allowing the chemicals to etch both the exposed photoresist and the transparent conducting electrode layers 50 and 55 below it, thus forming the desired pattern. The remaining photoresist can then be removed with other chemicals. A second variety of photoresist resists etching only after it is exposed to ultraviolet light; in this case, a negative mask of the desired pattern must be used.

After the transparent conducting electrodes (transparent conducting electrode layers 50 and 55) are deposited on the substrate (substrate surfaces 41 and 46) in a desired pattern, alignment layers are applied (step 730). For example, alignment layers 60 and 65 are applied on substrate surfaces 41 and 46 over transparent conducting electrode layers 50 and 55, respectively. Alignment layers 60 and 65 may comprise any material described above as suitable for alignment layers 60 and 65 in the discussion of FIG. 3. In various embodiments, alignment layers 60 and 65 may be applied using methods such as: dipping; spin coating; ultrasonic spraying; sputtering; or chemical vapor deposition.

After alignment layers (alignment layers 60 and 65) are applied on substrate surfaces 41 and 46 over transparent conducting electrode layers 50 and 55, respectively, the alignment layers are treated (step 740). The type of material comprising alignment layers 60 and 65 will dictate the type of treatment method used on alignment layers 60 and 65.

In one embodiment, alignment layers 60 and 65 may comprise a polymer layer suitable for mechanical alignment methods. Alignment layers 60 and 65 can be oriented using, for example, drawing techniques or rubbing with rayon or other cloth. The direction of the drawing or rubbing is based on the alignment desired for the default state of the cholesteric liquid crystal composition.

In another embodiment, alignment layers 60 and 65 may comprise inorganic or organic layers that can be textured using collimated ion beam irradiation.

In another embodiment, alignment layers 60 and 65 may comprise a photo-orientable polymer. For example, alignment layers 60 and 65 can be oriented using irradiation, or by using anisotropically absorbing molecules disposed in a medium or on a substrate with light (e.g., ultraviolet light) that is linearly polarized relative to the desired alignment direction.

After alignment layers (alignment layers 60 and 65) are treated, liquid crystal material is encapsulated (step 750). Liquid crystal material (e.g., cholesteric liquid crystal composition layer 70) may comprise any material described above as suitable for cholesteric liquid crystal composition layer 70 in the discussion of FIG. 3.

In one embodiment, liquid crystal material (e.g., cholesteric liquid crystal composition layer 70) is deposited on substrate surface 41 over transparent conducting electrode layer 50 and alignment layer 60. After the liquid crystal material is deposited on substrate surface 41 over transparent conducting electrode layer 50 and alignment layer 60, substrate layer 45 (with transparent conducting electrode layer 55 and alignment layer 65) is placed on substrate layer 40 in a desired alignment (such that alignment layers 60 and 65 are in contact with cholesteric liquid crystal composition layer 70) and sealed. For example, a suitable sealant may be an epoxy or acrylic adhesive, which can be dispensed on either substrate layer 40 or substrate layer 45 before or after disposition of liquid crystal material. The sealing may also be done by using laser welding.

In another embodiment, substrate layer 40 (with transparent conducting electrode layer 50 and alignment layer 60) is sealed to substrate layer 45 (with transparent conducting electrode layer 55 and alignment layer 65) in a desired alignment (such that alignment layers 60 and 65 are opposite from each other) and sealed. This process includes applying sealant around the periphery of substrate layer 40 or 45 such as to leave a fill port at a location on the periphery. After substrate layer 40 (with transparent conducting electrode layer 50 and alignment layer 60) is scaled to substrate layer 45 (with transparent conducting electrode layer 55 and alignment layer 65) in a desired alignment and sealed, the liquid crystal material is vacuum filled using the fill port left during the sealing process. After the liquid crystal is vacuum filled the fill port is also sealed. In other embodiments, a lamination process, such as roll-to-roll, may be used to encapsulate the liquid crystal material is encapsulated in step 750.

In some embodiments, after the liquid crystal material is encapsulated (in step 750), the liquid crystal material may be stabilized with a polymer network. Before encapsulation, polymer networks can be formed during the initial stages of liquid crystal composition preparation by combining a small quantity of reactive monomer, a photoinitiator with cholesteric liquid crystal molecules, and a small amount of chiral dopant to produce the desired pitch. The desired alignment of the liquid crystal material to be stabilized is established through the combination of surface preparations (before encapsulation) and applied field (after encapsulation). After the desired alignment is established, ultraviolet light may be used to photopolymerize the liquid crystal composition and stabilized the desired alignment.

In some embodiments, after the liquid crystal material is encapsulated (in step 750) and after an optional polymer stabilization step, the formed an adjustable focal length lens may be embedded in or attached to one of the surfaces of a larger lens. The larger lens may be a contact lens, glasses lens, camera lens, or any other lens. In another embodiment, two or more formed adjustable focal length lens may be arranged as in a compound lens and embedded in or attached to one of the surfaces of a larger lens.

In some embodiments, during the process of embedding or attaching the formed adjustable focal length lens to one of the surfaces of a larger lens, driving electronics are connected to the formed adjustable focal length lens and also embedded or attached to one surface of the larger lens. For example, the leads (formed in step 720) from transparent conducting electrode layers 50 and 55 that extend to the exterior of adjustable focal length lens 25 are connected to driving electronics using solder, conductive paste, or other suitable material.

FIG. 8 depicts an exemplary cross-sectional view of lens 10 having adjustable focal length lens 25 and adjustable focal length lens 810 integrated therein, in accordance with another embodiment of the present invention. Lens 10 is composed of lens material 35 and includes two surfaces, an outer surface 12 (being the surface closest to light source 15) and an inner surface 14 (being the surface farthest from light source 15), both of which are spherical. In other embodiments, the two surfaces may be parabolic or cylindrical. In yet another embodiment, if lens 10 is not specifically a lens, outer surface 12 and inner surface 14 may be any curved surface. The curved surface may be curved, “locally” curved, “piecewise curved.” Inner surface 14 is concave. Outer surface 12 is convex and opposite inner surface 14. Lens 10 has a thickness that spans in a horizontal direction between inner surface 14 and outer surface 12. Adjustable focal length lens 25 and adjustable focal length lens 810 are located within the thickness of lens 10.

In one embodiment, adjustable focal length lens 25 and adjustable focal length lens 810 are in contact such that they share a common surface (e.g., an outer surface of substrate layer 45). In other embodiments, adjustable focal length lens 25 and adjustable focal length lens 810 do not have to be in direct contact. Adjustable focal length lens 25 and adjustable focal length lens 810 are also arranged one after the other with a common axis as in a compound lens. In some embodiments, the distance between adjustable focal length lens 25 and adjustable focal length lens 810 is variable. For example, lens 10 may be some structures, such as camera lens, that may allow the positioning of adjustable focal length lens 25 and adjustable focal length lens 810 to be adjusted. In one embodiment, if lens 10 is a contact lens, adjustable focal length lens 25 and adjustable focal length lens 810 are positioned within lens 10 such that adjustable focal length lens 25 and adjustable focal length lens 810 are in the optical region of the contact lens (e.g., the center region of the contact, about 6 mm in diameter) leaving the outer region of the contact lens for driving electronics.

Lens material 35 can include any suitable material that provides support for adjustable focal length lens 25, contain adjustable focal length lens 25, and/or otherwise form a structural and/or functional body of lens 10. Lens material 35 is substantially transparent and biocompatible. In one embodiment, lens material 35 comprises a soft polymer material including but not limited to, a hydrogel, a silicone based hydrogel, a polyacrlyamide, or a hydrophilic polymer. In other embodiments, lens material 35 may comprise polyethylene terephthalate (“PET”), polymethyl methacrylate (“PMMA”), polyhydroxyethylmethacrylate (polyHEMA) based hydrogels, or combinations thereof. I yet another embodiment, lens material 35 may comprise a rigid gas permeable material. In yet another embodiment, lens material may comprise glass, plastic (such as a polycarbonate), or any other suitable material. In one embodiment, lens material 35, outer surface 12, and inner surface 14 comprise the same material. In other embodiments, lens material 35 may comprise a different material than outer surface 12 and inner surface 14.

Adjustable focal length lens 25 is composed of a plurality of layers, including substrate layer 40 and substrate layer 45. Adjustable focal length lens 25 also comprises substrate surface 41 and substrate surface 46 which are the inner surfaces of substrate layer 40 and substrate layer 45, respectively (as shown in FIG. 3). Substrate surface 41 and substrate surface 46 both may be spherical, parabolic, or any curved surface. Substrate surface 46 is concave. Substrate surface 41 is convex and opposite substrate surface 46. In general, as illustrated in FIG. 8, the width of adjustable focal length lens 25 is thinnest (relative to the width of adjustable focal length lens 25 at other areas) at the center point of adjustable focal length lens 25, tapering outwardly to a thicker edge at the perimeter of adjustable focal length lens 25. The plurality of layers of adjustable focal length lens 25 are discussed in detail with reference to FIG. 3.

Adjustable focal length lens 810 is composed of a plurality of layers, including a substrate layer in contact with substrate layer 45 and substrate layer 820. Adjustable focal length lens 810 also comprises two substrate surfaces which are the inner surfaces of the substrate layer in contact with substrate layer 45 and substrate layer 820. The two substrate surfaces both may be spherical, parabolic, or cylindrical. The substrate surface that is the inner surface of substrate layer 820 is concave. The substrate surface that is the inner surface of the substrate layer in contact with substrate layer 45 is convex and opposite the substrate surface that is the inner surface of substrate layer 820. In general, as illustrated in FIG. 8, the width of adjustable focal length lens 810 is thinnest (relative to the width of adjustable focal length lens 810 at other areas) at the center point of adjustable focal length lens 810, tapering outwardly to a thicker edge at the perimeter of adjustable focal length lens 810. The plurality of layers of adjustable focal length lens 810 can be substantially similar to the layers of adjustable focal length lens 25 as discussed in detail with reference to FIG. 3.

The particular dimensions (including dimensions attributable to thickness, diameter, curvature, and etc.) of adjustable focal length lens 810 may vary. The particular dimensions of adjustable focal length lens 810 can be tailored such that adjustable focal length lens 810 has a particular focal length (or power). The focal length of a lens can be determined using the lens maker's equation, as shown in Equation (1), or the thin lens approximation equation, as shown in Equation (2) above.

In one embodiment, adjustable focal length lens 25 and adjustable focal length lens 810 are in contact and arranged one after the other with a common axis as in a compound lens. With the lenses placed in contact and arranged one after another along a common axis to form a compound lens, the lenses can be tailored such that the compound lens has a particular focal length (or power). The focal length of a compound lens can be determined using the following equations: Equation (3) if the lenses are in direct contact; and Equation (4) if the lenses are separated by some distance d.

$$\begin{matrix}\frac{1}{f} = \frac{1}{{f}_{1}} + \frac{1}{{f}_{2}} . & Equation ( 3 ) \\ \frac{1}{f} = \frac{1}{{f}_{1}} + \frac{1}{{f}_{2}} - \frac{d}{{f}_{1} {f}_{2}} . & Equation ( 4 )\end{matrix}$$

In various embodiments, two or more adjustable focal length lens may be combined to form a compound lens. Combining two or more adjustable focal length lenses allows for increased range of adjustability of focal length. Combining two or more adjustable focal length lenses may allow for any number of applications and combinations, some examples of which are described below.

In one embodiment, adjustable focal length lens 25 and adjustable focal length lens 810 each have a cholesteric liquid crystal composition layer. Each respective cholesteric liquid crystal composition layer two states n=nₑ (the default state when no voltage is applied) and n=nₒ when a voltage is applied (see discussion of FIG. 3). Because each respective cholesteric liquid crystal composition layer of adjustable focal length lens 25 and adjustable focal length lens 810 has two states (for lens 25 n_{1,o}, n_{1,e} and for lens 810 n_{2,o}, n_{2,e}), the compound lens has four states plus intermediate states. The four states may be: state 1 (n_{1,o}; n_{2,o}), state 2 (n_{1,o}; n_{2,e}), state 3 (n_{1,e}; n_{2,o}), and state 4 (n_{1,e}; n_{2,e}).

In one embodiment, each respective cholesteric liquid crystal composition layer of adjustable focal length lens 25 and adjustable focal length lens 810 have the same pitch but with opposite twists (one right handed and the other left handed). This ensures that light of the same wavelength as the pitch will be completely reflected. This embodiment may provide for an adjustable focal length lens that may be used as a band gap filter (e.g., UV, IR, a color filter, a microwave filter, a polarizer, or antiglare filter).

In another embodiment, two or more sets of adjustable focal length lenses (a set being adjustable focal length lens 25 and adjustable focal length lens 610 as listed in the paragraph above) may be used together. Each set may have a different pitch. This embodiment may provide for a compound adjustable focal length lens that may be used as a multiple band gap filter.

In another embodiment, each respective cholesteric liquid crystal composition layer of adjustable focal length lens 25 and adjustable focal length lens 810 has a different pitch either with opposite twists (one right handed and the other left handed) or the same twists. This embodiment may provide for an adjustable focal length lens that may be used as switchable multiple color filter or changeable color contact lens.

In another embodiment, each respective cholesteric liquid crystal composition layer of adjustable focal length lens 25 and adjustable focal length lens 810 has a different pitch either with opposite twists (one right handed and the other left handed) or the same twists. This embodiment may provide for an adjustable focal length lens that may be used for UV protection and variability of focal lengths.

In one embodiment, lens 10 is a contact lens having adjustable focal length lens 25 and adjustable focal length lens 810 integrated therein. Lens 10 is composed of lens material 35. In this embodiment, lens material 35 is a hydrogel as used in contact lenses. Lens 10 includes two surfaces, an outer surface 12 and an inner surface 14, both of which are spherical. Adjustable focal length lens 25 and adjustable focal length lens 810 are positioned within lens 10 such that adjustable focal length lens 25 and adjustable focal length lens 810 are in the optical region of the contact lens (e.g., the center region of the contact, about 6 mm in diameter) leaving the outer region of the contact lens for driving electronics. Adjustable focal length lens 25 is composed of a plurality of layers, including substrate layer 40 and substrate layer 45. Adjustable focal length lens 25 also comprises substrate surface 41 and substrate surface 46 which are the inner surfaces of substrate layer 40 and substrate layer 45, respectively (as shown in FIG. 3). Substrate surface 41 and substrate surface 46 are both spherical. Adjustable focal length lens 810 is composed of a plurality of layers, including a substrate layer in contact with substrate layer 45 and substrate layer 820. Adjustable focal length lens 810 also comprises two substrate surfaces which are the inner surfaces of the substrate layer in contact with substrate layer 45 and substrate layer 820, both of which are spherical.

Having described embodiments of a cholesteric liquid crystal adjustable focal length lens (which are intended to be illustrative and not limiting), it is noted that modifications and variations may be made by persons skilled in the art in light of the above teachings. It is therefore to be understood that changes may be made in the particular embodiments disclosed which are within the scope of the present invention as outlined by the appended claims.

What is claimed is:

1. An adjustable focal length lens structure, comprising:
a first adjustable focal length lens, comprising:
an inner surface of a first side having a first curvature;
a first transparent conducting electrode on the first side;
an inner surface of a second side having a second curvature;
a second transparent conducting electrode on the second side; and
one or more layers of a first liquid crystal material disposed between the inner surface of the first side and the inner surface of the second side, wherein the first liquid crystal material has two or more effective indices of refraction.

2. The adjustable focal length lens structure of claim 1, wherein the first liquid crystal material comprises a cholesteric liquid crystal material.

3. The adjustable focal length lens structure of claim 1, wherein the first transparent conducting electrode is on the inner surface of the first side and the second transparent conducting electrode is on the inner surface of the second side.

4. The adjustable focal length lens structure of claim 1, wherein an effective index of refraction of the two or more effective indices of refraction of the first liquid crystal material is selected by application of a voltage between the first transparent conducting electrode and the second transparent conducting electrode only during a period of time when the voltage is applied.

5. The adjustable focal length lens structure of claim 1, wherein an effective index of refraction of the two or more effective indices of refraction of the first liquid crystal material is selected by application of a temporary voltage between the first transparent conducting electrode and the second transparent conducting electrode, wherein the effective index of refraction is stable after the temporary voltage is removed and until another temporary voltage is applied.

6. The adjustable focal length lens structure of claim 1, wherein the one or more layers of the first cholesteric liquid crystal material includes an embedded anisotropic polymer network, wherein the embedded anisotropic polymer network stabilizes a molecular orientation of the first cholesteric liquid crystal material.

7. The adjustable focal length lens structure of claim 1, wherein the first transparent conducting electrode and the second transparent conducting electrode each comprise two or more pixilated transparent conducting electrodes in a pattern.

8. The adjustable focal length lens structure of claim 7, wherein the pattern comprises concentric annuli.

9. The adjustable focal length lens structure of claim 7, wherein the pattern comprises concentric arcs.

10. The adjustable focal length lens structure of claim 7, wherein the pattern comprises rectangular pixels.

11. The adjustable focal length lens structure of claim 7, wherein each pixilated transparent conducting electrode of the two or more pixilated transparent conducting electrodes is wired to a power source such that each pixilated transparent conducting electrode receives a specific voltage.

12. The adjustable focal length lens structure of claim 11, wherein specific voltages applied to the two or more pixilated transparent conducting electrodes are configured to achieve a desired spatial distribution of the two or more effective indices of refraction.

13. The adjustable focal length lens structure of claim 11, wherein the desired optical effect is one or more of the following: a personalized 2D mapping of vision correction; a bifocal effect; a progressive lenses effect; a filtering effect; an astigmatism correction effect; a double vision correction effect; a myopia correction effect; or a hyperopia correction effect.

14. The adjustable focal length lens structure of claim 1, wherein the first adjustable focal length lens has a focal length based on a molecular orientation of the first cholesteric liquid crystal material disposed between the inner surface of the first side and the inner surface of the second side.

15. The adjustable focal length lens structure of claim 1, wherein the two or more effective indices of refraction of the first cholesteric liquid crystal material are based on the a configuration of the first cholesteric liquid crystal material disposed between the inner surface of the first side and the inner surface of the second side.

16. The adjustable focal length lens structure of claim 1, wherein one or both inner surface of the first side and the second side are a set of surfaces with the same curvature offset by step discontinuity.

17. The adjustable focal length lens structure of claim 1, further comprising:
a second adjustable focal length lens, comprising:
an inner surface of a third side having a third curvature;
a third transparent conducting electrode on the third side;
an inner surface of forth side having a forth curvature;
a forth transparent conducting electrode on the forth side; and
one or more layers of a second liquid crystal material disposed between the inner surface of the third side and the inner surface of the forth side.

18. The adjustable focal length lens structure of claim 17, wherein the third transparent conducting electrode is on the inner surface of the third side and the fourth transparent conducting electrode is on the inner surface of the fourth side.

19. The adjustable focal length lens structure of claim 17, wherein the first adjustable focal length lens and the second adjustable focal length lens are arranged about a common optical axis as in a compound lens.

20. The adjustable focal length lens structure of claim 17, wherein the first liquid crystal material is one of the following: transparent to visible light; or reflective to a specific wavelength of light, such as, ultra violet, infrared, or a specific range of the visible light spectrum.

21. The adjustable focal length lens structure of claim 17, wherein the second liquid crystal material is one of the following: transparent to visible light; or reflective to a specific wavelength of light, such as, ultra violet, infrared, or a specific range of the visible light spectrum.

22. The adjustable focal length lens structure of claim 1, wherein the first cholesteric liquid crystal material has a birefringence in the range of about 0.1 to 0.5.

23. The adjustable focal length lens structure of claim 1, wherein the first cholesteric liquid crystal material has a birefringence in the range of about 0.1 to 0.3.

24. The adjustable focal length lens structure of claim 1, wherein the first adjustable focal length lens has a thickness in the range of about 2 microns to 100 microns.

25. The adjustable focal length lens structure of claim 1, wherein the first adjustable focal length lens has a thickness in the range of about 5 microns to 15 microns.

26. The adjustable focal length lens structure of claim 1, wherein the inner surfaces of the first side and the second side are each one of the following: convex, concave, or planar.

27. The adjustable focal length lens structure of claim 17, wherein the inner surfaces of the first side, the second side, the third side, and the forth side are each one of the following: convex, concave, or planar.

28. The adjustable focal length lens structure of claim 1, further comprising:
a structure, wherein the first adjustable focal length lens is disposed fully within the structure, and wherein the structure is one or a combination of the following: a camera lens, a contact lens, a lens for glasses, or a handheld lens.

29. The adjustable focal length lens structure of claim 1:
wherein the first adjustable focal length lens is in a preferred default state, wherein the preferred state is such that the first liquid crystal material disposed between the inner surface of the first side and the inner surface of the second side is set to a preferred index of refraction of the two or more effective indices of refraction; and
wherein an applied voltage can adjust the first adjustable focal length lens away from the preferred default state.

30. The adjustable focal length lens structure of claim 17, wherein a distance between the first adjustable focal length lens and the second adjustable focal length lens is fixed or variable.

31. The adjustable focal length lens structure of claim 1, further comprising:
driving electronics, wherein the driving electronics are capable of receiving input and adjusting the first adjustable focal length lens based on the input.

32. The adjustable focal length lens structure of claim 31, wherein the driving electronics are one or more of the following: one or more sensors or smart sensors from bio-metric input; one or more sensors; one or more smart sensors; one or more wireless antenna devices; one or more integrated power supplies such as an integrated battery, capacitor or other power source; one or more integrated energy scavenging devices; one or more external power sources; one or more control circuits; or one or more storage devices.

33. In one embodiment, adjustable focal length lens 25 itself can be made with a saw tooth structure (as shown in FIG. 6) to reduce the thickness difference while preserving the curvature as described in reference to FIG. 6.

34. A contact lens, comprising:
an inner surface of a first side having a first curvature;
an inner surface of a second side having a second curvature; and
a first adjustable focal length lens, comprising:
an inner surface of a third side having a third curvature;
a first transparent conducting electrode on the third side;
an inner surface of a fourth side having a fourth curvature;
a second transparent conducting electrode on the fourth side; and
one or more layers of a first liquid crystal material disposed between the inner surface of the third side and the inner surface of the fourth side, wherein the first liquid crystal material has two or more effective indices of refraction.

35. The contact lens of claim 34, further comprising:
driving electronics, wherein the driving electronics are connected to the first transparent conducting electrode and the second transparent conducting electrode of the first adjustable focal length lens.

36. The contact lens of claim 35, wherein the driving electronics are one or more of the following: one or more sensors or smart sensors from bio-metric input; one or more sensors; one or more smart sensors; one or more wireless antenna devices; one or more integrated power supplies such as an integrated battery, capacitor or other power source; one or more integrated energy scavenging devices; one or more external power sources; one or more control circuits; or one or more storage devices.
